(19) United States
(12) Patent Application Publication
(10) Pub. No.: US 2025/0093646 A1
(43) Pub. Date: Mar. 20, 2025

(54) Hybrid Folded Birdbath Display

(71) Applicant: Apple Inc., Cupertino, CA (US)

(72) Inventors: Pablo Benitez Gimenez, Madrid (ES); Julio Chaves, Redwood City, CA (US); Dejan Grabovickic, Madrid (ES); Juan Carlos Minano Dominguez, Mountain View, CA (US); Zachary A Granger, Redwood City, CA (US)

(21) Appl. No.: 18/806,514

(22) Filed: Aug. 15, 2024

Related U.S. Application Data
(60) Provisional application No. 63/583,093, filed on Sep. 15, 2023.

(51) Int. Cl. G02B 27/01

(52) U.S. Cl. CPC G02B 27/0101

(57) ABSTRACT

An electronic device may include a display with a display panel that emits light into an optical system. The system provides the light and world light to an eye box. The system may be implemented using a folded birdbath architecture. The system may include a partial reflector and a reflective polarizer in freeform curved rotationally asymmetric surfaces. The system may include two or three optical wedges. An air gap may separate two of the wedges. A quarter waveplate may be layered over the reflective polarizer and/or the partial reflector. A privacy filter may overlap the partial reflector. The wedges may perform total internal reflections on the light. The system may provide a horizontal field of view of the light to the eye box at a different point than a vertical field of view. A switchable shutter may overlap the system and may be synchronized to an external device display.

This application claims the benefit of U.S. Provisional Patent Application No. 63/583,093, filed Sep. 15, 2023, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays. If care is not taken, the optical elements can be excessively bulky and/or might not exhibit sufficient levels of optical performance.

### SUMMARY

An electronic device may include a display. The display may include an optical system and a display panel. The display panel may emit image light into the optical system. The optical system may provide the image light and world light to an eye box. The optical system may be implemented using a folded birdbath architecture.

The optical system may include a partial reflector and a reflective polarizer in different respective curved surfaces. The curved surfaces may be freeform curved and rotationally asymmetric. If desired, the optical system may include two or three optical wedges. If desired, an air gap may separate two of the optical wedges. A quarter waveplate may be layered over the reflective polarizer and/or the partial reflector (e.g., within the air gap). A privacy filter such as a quarter waveplate and an absorptive polarizer may overlap the partial reflector to prevent the image light from leaking into the surroundings. If desired, the optical wedges may be configured to perform two total internal reflections of the light. If desired, the optical system may provide a horizontal field of view of the image light to the eye box at a different point than the vertical field of view. If desired, a switchable shutter may overlap the optical system and may be synchronized to the display on an external device for transmitting light from the display to the eye box.

### BRIEF DESCRIPTION OF THE DRAWINGS

FIG. 1 is a diagram of an illustrative system having a display in accordance with some embodiments.

FIG. 2 is a top view of an illustrative optical system for providing virtual objects overlaid with real-world object to eye boxes in accordance with some embodiments.

FIG. 3 is a top view of an illustrative optical system having freeform curved surfaces for providing light to an eye box in accordance with some embodiments.

FIG. 4 is a top view of an illustrative optical system having freeform curved surfaces and an air gap for providing light to an eye box in accordance with some embodiments.

FIG. 5 is an optical diagram showing how optical layers in an optical system of the type shown in FIG. 3 may direct image light and world light to an eye box in accordance with some embodiments.

FIG. 6 is an optical diagram showing how optical layers in an optical system of the type shown in FIG. 3 and provided with a privacy filter may direct image light and world light to an eye box in accordance with some embodiments.

FIG. 7 is a top view of an illustrative optical system that provides light to an eye box after two total internal reflections of the light in accordance with some embodiments.

FIG. 8 is a perspective view of an illustrative optical system that provides light to an eye box having a uniform width and height in accordance with some embodiments.

FIG. 9 is a diagram showing how an illustrative optical system of the types shown in FIGS. 1-8 may be provided with a switchable filter for transmitting display light from an external device in accordance with some embodiments.

### DETAILED DESCRIPTION

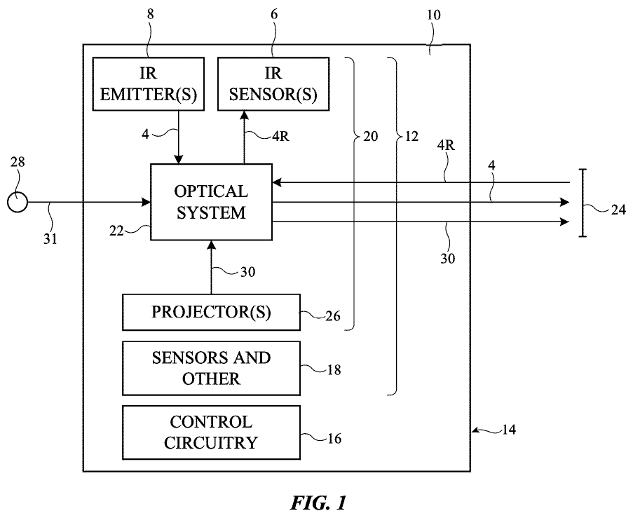

System 10 of FIG. 1 may be an electronic device such as a head-mounted device having one or more displays. The displays in system 10 may include near-eye displays 20 mounted within support structure such as housing 14. Housing 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as housing 14. Each projector 26 may emit image light 30 that is redirected towards a user's eyes at eye box 24 using an associated one of optical systems 22. Image light 30 may be, for example, visible light (e.g., including wavelengths from 400-700 nm) that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner formed from reflective components, diffractive components, refractive components, a waveguide, a direct view optical combiner, and/or other optics) to allow real-world light (sometimes referred to as world light 31) from real-world (external) objects such as real-world (external) object 28 to be combined optically with virtual (computer-generated) images such as virtual images in image light 30. In this type of system, which is sometimes referred to as an augmented reality system, a user of system 10 may view both real-world content (e.g., world light 31 from object 28) and computer-generated content that is overlaid on top of the real-world content. Camera-based augmented reality systems may also be used in device 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify and track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 15 microns). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may reflect off portions (regions) of the user's eye at eye box 24 as reflected light 4R (sometimes referred to herein as reflected sensor light 4R, which is a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. Infrared sensor(s) 6 and infrared emitter(s) 8 may be omitted if desired.

Optical system 22 may include any desired optics for directing image light 30 and world light 31 to eye box 24. In some implementations, optical system 22 includes left and right waveguides that provide left and right image light to respective left and right eye boxes. The waveguides propagate the image light via total internal reflection (TIR). Each waveguide may include an input coupler that couples image light into the waveguide, an output coupler that couples the image light out of the waveguide, and optionally a cross coupler or pupil expander for redirecting and/or expanding the image light propagating within the waveguide via TIR. The input coupler, output coupler and/or cross coupler may include diffractive structures such as surface relief gratings, volume holograms, metagratings, or other diffractive gratings, reflective structures such as louvered mirrors, and/or any other desired optical coupling structures.

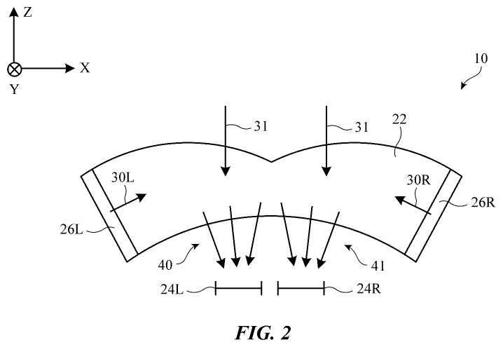

In other implementations, which are described herein as an example, optical system 22 may include optics arranged in a folded birdbath architecture. FIG. 2 is a top view showing one example of how optical system 22 may be implemented using a birdbath architecture. As shown in FIG. 2, optical system 22 may include optics arranged in a folded birdbath arrangement. System 10 may include a first (left) projector 26L that emits image light 30L into optical system 22 (e.g., images for view by the user's left eye). System 10 may include a second (right) projector 26R that emits image light 30R (e.g., images for view by the user's right eye).

Optical system 22 may redirect image light 30L to left eye box 24L via three or more reflections within optical system 22, as shown by arrows 40. Optical system 22 may also redirect image light 30R to right eye box 24R via three or more reflections within optical system 22, as shown by arrows 41. Optical system 22 may also perform one or more refractions on image light 30L/30R if desired. At the same time, optical system 22 may transmit world light 31 to eye boxes 24L and 24R (e.g., for overlaying the world light with virtual images in image light 30L and 30R).

Projectors 26L and 26R may include respective emissive display panels and are therefore sometimes referred to herein as display panels 26L and 26R. Each display panel may include an array of pixels (e.g., emissive light sources that each emit a respective pixel of the image light). The pixels may be formed from light-emitting diodes, organic light-emitting diodes, or lasers, as examples. If desired, display panel 26L may be replaced with two adjacent emissive display panels (e.g., for emitting two respective channels of image light 30L) and/or display panel 26R may be replaced with two adjacent emissive display panels (e.g., for emitting two respective channels of image light 30R).

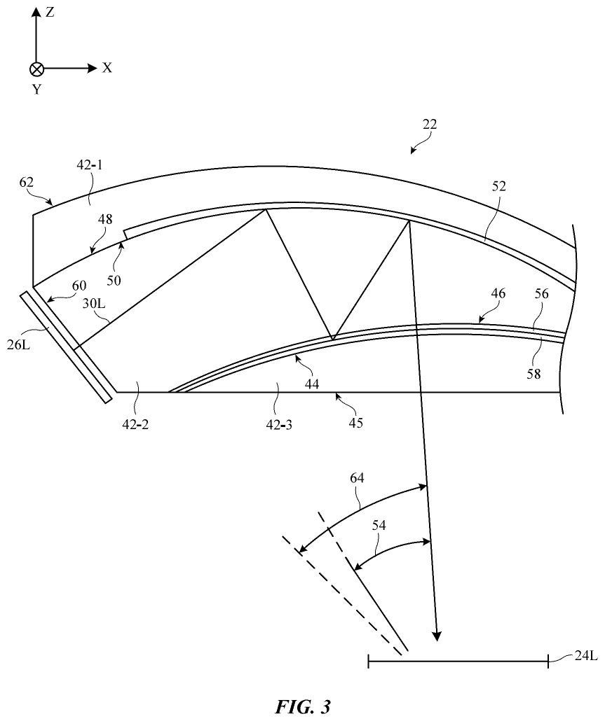

FIG. 3 is a cross-sectional top view of the left side of optical system 22 (e.g., including projector 26L that provides image light 30L to left eye box 24L). Similar structures may be used to form the right side of optical system 22 (e.g., for providing image light 30R from projector 26R to right eye box 24R of FIG. 2).

As shown in FIG. 3, optical system 22 may include one or more optical substrates such as optical wedges 42. Optical system 22 may include, for example, a first optical wedge 42-1, a second optical wedge 42-2, and a third optical wedge 42-3. Optical wedge 42-2 may be layered, disposed, interposed, or sandwiched between optical wedges 42-1 and 42-3. Alternatively, optical wedges 42-1 and/or 42-3 may be omitted.

Optical wedge 42-2 may have a light receiving surface 60. Display panel 26L may overlap light receiving surface 60. Display panel 26L may be layered onto light receiving surface 60 or may be separated from light receiving surface 60 by an air gap. If desired, one or more lenses (not shown) may be optically coupled between display panel 26L and light receiving surface 60.

Optical wedge 42-2 may have a first surface 50 and a second surface 46 opposite surface 50. Light receiving surface 60 may extend from surface 50 to surface 46. Optical wedge 42-1 may have a first surface 48 and a second surface 62 opposite surface 48. Surface 48 may be layered onto or pressed against surface 50 of optical wedge 42-2. Optical wedge 42-3 may have a first surface 44 and a second surface 45 opposite surface 44. Surface 44 may be layered onto or pressed against surface 46 of optical wedge 42-1.

One or more optical layers may be disposed on one or more of the surfaces of optical wedges 42-1, 42-2, and/or 42-3 for redirecting image light 30L and/or world light. For example, optical system 22 may include a partial reflector 52 layered onto surface 50 of optical wedge 42-2 and/or surface 48 of optical wedge 42-1 (e.g., partial reflector 52 may be sandwiched between surfaces 48 and 50). Optical system 22 may include a reflective polarizer 58 layered onto surface 44 of optical wedge 42-3. Optical system 22 may include a quarter wave plate (QWP) 56 layered onto surface 46 of optical wedge 42-2 (e.g., between surface 46 and reflective polarizer 58).

Reflective polarizer 58 may reflect a first polarization of light while transmitting a second (e.g., orthogonal) polarization of light. Reflective polarizer 58 may be formed as a film or coating layered onto QWP 56 or surface 44 of optical wedge 42-3. QWP 56 may be formed as a film or coating layered onto surface 46 of optical wedge 42-2 or on reflective polarizer 58.

Partial reflector 52 may be layered onto surface 48 or surface 50. Partial reflector 52 is sometimes also referred to herein as partial mirror 52. Partial reflector 52 may transmit a first amount of incident light while reflecting a remainder of the incident light. Partial reflector 52 may, for example, transmit 50% of incident light while reflecting 50% of the incident light (e.g., partial reflector 52 may be a 50-50 mirror), may transmit 20% of incident light while reflecting 80% of the incident light (e.g., partial reflector 52 may be an 80-20 mirror), etc. Partial reflector 52 may be, for example, a dielectric mirror formed from a multi-layer dielectric stack of layers, films, or coatings.

During operation, projector 26L may emit image light 30L into optical wedge 42-2 through light receiving surface 60. A single ray of image light 30L is illustrated in FIG. 3 for the sake of clarity. Image light 30L passes through optical wedge 42-2, where the image light reflects off partial reflector 52 and towards surface 46. Image light 30L is reflected a second time by reflective polarizer 58. The twice-reflected image light 30L passes back through optical wedge 42-2 to partial reflector 52. Partial reflector 52 reflects image light 30L for a third time, back towards surface 46. After the third reflection, QWP 56 and reflective polarizer 58 transmit image light 30L to eye box 24L.

In some implementations, the reflective and/or transmissive interfaces of optical system 22 exhibit rotational symmetry about the optical axis of optical system 22. For example, surface 50, surface 48, partial reflector 52, surface 46, surface 44, QWP 56, and/or reflective polarizer 58 may exhibit rotational symmetry (e.g., spherical curvature or other curvatures) about the optical axis of optical system 22 or another axis. To help increase the field of view and eye relief (ER) performance of optical system 22 relative to these implementations, surface 50, surface 48, partial reflector 52, surface 44, surface 46, QWP 56, and/or reflective polarizer 58 may have freeform curvature(s) that is/are not rotationally symmetric about the optical axis of optical system 22.

Put differently, surface 50, surface 48, partial reflector 52, surface 44, surface 46, QWP 56, and/or reflective polarizer 58 may lie within respective three-dimensional surfaces having freeform three-dimensional curvatures that are not rotationally symmetric about the optical axis of optical system 22 and/or display panel 26L (e.g., surface 50, surface 48, partial reflector 52, surface 44, surface 46, QWP 56, and/or reflective polarizer 58 may be rotationally asymmetric about the optical axis). Implementing optical system 22 using these freeform and rotationally asymmetric curvatures may configure optical system 22 to exhibit a half-field of view 64 (e.g., 35-45 degrees, corresponding to a total FOV of 70-90 degrees) that is greater than the half-field of view 54 of optical system 22 in implementations where the curvatures are rotationally symmetric about the optical axis of optical system 22 (e.g., 15-25 degrees, corresponding to a total FOV of 30-50 degrees), while also allowing for a reduction in the overall thickness of optical system 22 (e.g., parallel to the Z-axis).

The example of FIG. 3 is merely illustrative. In another suitable implementation, optical wedge 42-2 may be omitted (e.g., replaced with a hollow air cavity between optical wedges 42-1 and 42-3). In this implementation, reflective polarizer 58 and QWP 56 are layered onto surface 44 of optical wedge 42-3 and partial reflector 52 is layered onto surface 48 of optical wedge 42-1. Implementing optical system 22 using this type of hollow architecture may further reduce the thickness of optical system 22 (e.g., parallel to the Z-axis), may be birefringence free, and may weigh less than implementations where optical wedge 42-2 is included. On the other hand, implementing optical system 22 with optical wedge 42-2 may increase the field of view of optical system 22 relative to omitting optical wedge 42-2.

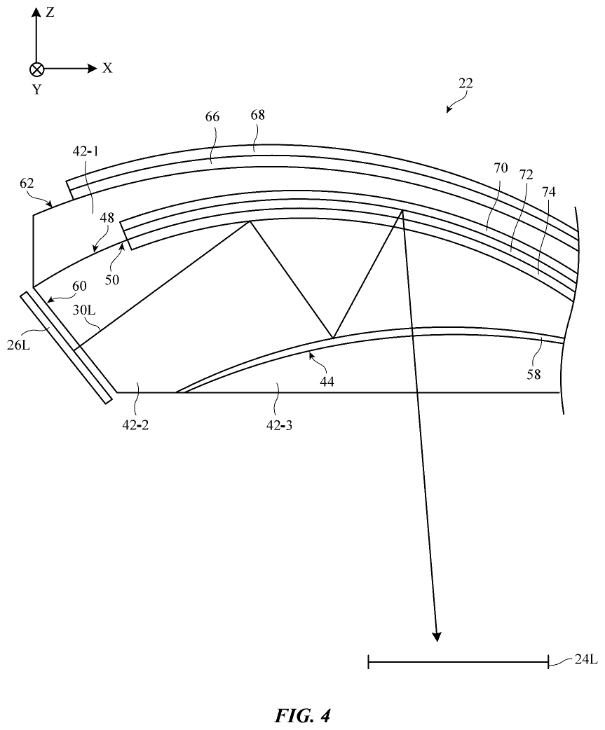

If desired, an air gap may be disposed between optical wedge 42-2 and optical wedge 42-1 to help increase the optical efficiency of optical system 22. FIG. 4 is a cross-sectional side view showing one example of how optical system 22 may include an air gap between optical wedges 42-2 and 42-1.

As shown in FIG. 4, optical system 22 may include an air gap 74 (or another material having a relatively low refractive index) between surface 50 of optical wedge 42-2 and surface 48 of optical wedge 42-1. Optical system 22 may include one or more optical layers layered onto surface 48 of optical wedge 42-1 such as partial mirror 70 (e.g., a 50-50 mirror) and QWP 72. QWP 72 and partial mirror 70 may overlap air gap 74. Partial mirror 70 may, for example, be layered onto surface 48 between QWP 72 and surface 48. QWP 72 may be interposed between partial mirror 70 and air gap 74. In this implementation, QWP 56 (FIG. 3) may be omitted from surface 46 of optical wedge 42-2.

During operation, projector 26L may emit image light 30L into optical wedge 42-2 through light receiving surface 60. A single ray of image light 30L is illustrated in FIG. 4 for the sake of clarity. Image light 30L passes through optical wedge 42-2, where the image light first reflects off a portion of surface 50 overlapping air gap 74 via TIR (e.g., in a total internal reflection since the dielectric constant of air gap 74 is less than that of optical wedge 42-2). The TIR reflection serves to reduce loss of the image light relative to the first reflection in FIG. 3 because all of the image light is total internally reflected, such that none of the image light reaches partial reflector 70 and therefore none of the image light is transmitted by the partial reflector instead of being reflected back into optical wedge 42-2. This may serve to increase the overall optical efficiency of optical system 22.

After the total internal reflection, image light 30L passes through optical wedge 42-2 to reflective polarizer 58. Image light 30L is reflected a second time by reflective polarizer 58. The twice-reflected image light 30L passes back through optical wedge 42-2 towards surface 50. After the second reflection, image light 30L is incident upon surface 50 outside the TIR range of optical wedge 42-2 (e.g., given the difference in dielectric constant between optical wedge 42-2 and air gap 74 and Snell's law). As such, image light 30L is transmitted through surface 50 and to partial reflector 70 through QWP 72. Partial reflector 70 reflects some of the image light 30L back towards optical wedge 42-2 through air gap 74 (in a third reflection of image light 30L). After the third reflection, optical wedge 42-2 transmits the image light to eye box 24L through optical wedge 42-3.

In the implementations of FIGS. 3 and 4, some of the image light 30L is transmitted by a partial reflector (e.g., partial reflector 52 of FIG. 3 or partial reflector 70 of FIG. 4) towards the world. If desired, optical system 22 may include a privacy filter that helps to block the image light transmitted by the partial reflector from passing to the world. For example, as shown in FIG. 4, optical system 22 may include a privacy filter formed from a QWP 66 layered onto surface 62 of optical wedge 42-1 and an absorption polarizer 68 layered onto QWP 66. QWP 66 and absorption polarizer 68 may also be layered onto surface 62 of FIG. 3 if desired. In other suitable implementations, QWP 66 and absorption polarizer 68 may be layered onto partial reflector 70 (e.g., at surface 48 of optical wedge 42-1) or may be separated from surface 62 of optical wedge 42-1 by an air gap. QWP 66 and absorption polarizer 68 may collectively block image light 30L that has been transmitted by partial reflector 70 (or partial reflector 52 of FIG. 3) from passing to the world. This may help to prevent others around device 10 from being able to view the images being provided to eye box 24L.

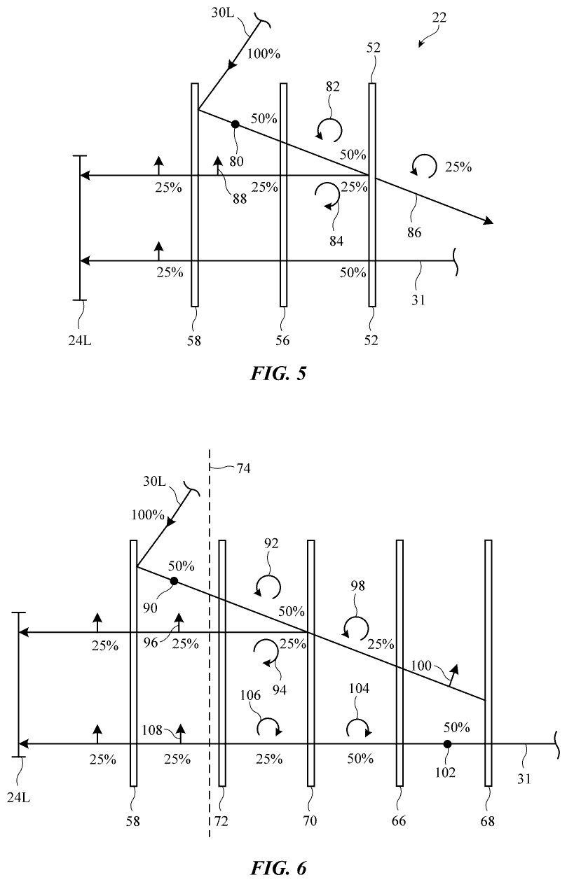

FIG. 5 is an optical diagram showing how reflective polarizer 58, QWP 56, and partial reflector 52 of FIG. 3 interact with image light 30L from projector 26L and world light 31 from the environment. As shown in FIG. 5, reflective polarizer 58, QWP 56, and partial reflector 52 may be disposed on the optical path of image light 30L from projector 26L to eye box 24L and on the optical path of world light 31 from the environment to eye box 24L.

Image light 30L may be incident upon reflective polarizer 58 from projector 26L. The incident image light is unpolarized and exhibits 100% intensity (brightness). Reflective polarizer 58 reflects half (50%) of image light 30L towards QWP 56 as linearly polarized light (e.g., linearly polarized in a direction 80). QWP 56 transmits the linearly polarized light towards partial reflector 52, converting the linearly polarized light to circular polarized light (e.g., circularly polarized in direction 82).

Partial reflector 52 transmits half of the incident circular polarized light (e.g., 25% of the image light 30L output by projector 26L), as shown by arrow 86 (e.g., without changing the circular polarization). At the same time, partial reflector 52 reflects half of the incident circular polarized light back towards QWP 56, reversing the direction of the circular polarization (e.g., into direction 84). In this example, partial reflector 52 is a 50-50 mirror. However, in general, partial reflector 52 may reflect or transmit any desired amount of incident light.

QWP 56 transmits the circular polarized light from partial reflector 52 towards reflective polarizer 58, converting the circular polarization from direction 84 into a linear polarization at direction 88 (e.g., orthogonal to direction 80). Reflective polarizer 58 reflects light that is linearly polarized in direction 80 and transmits light that is linearly polarized in direction 88. As such, reflective polarizer 58 transmits the linearly polarized light transmitted by QWP 56 to eye box 24L (e.g., without changing the polarization of the light). In this way, the image light 30L is received at eye box 24L at approximately 25% the intensity as emitted by projector 26L.

At the same time, world light 31 is received at partial reflector 52 as unpolarized light. Partial reflector 52 transmits half of world light 31 to QWP 56. Since the world light 31 transmitted by partial reflector 52 is unpolarized, QWP 56 transmits the world light without altering its polarization. Reflective polarizer 58 then transmits half of the world light from QWP 56 to eye box 24L as linearly polarized light that is polarized in direction 88. Since some of image light 38 is transmitted towards the world by partial reflector 52 (as shown by arrow 86), other people around device 10 may view content displayed by projector 26L. To help protect the privacy of the user of device 10, optical system 22 may include QWP 66 and absorption polarizer 68 (FIG. 4).

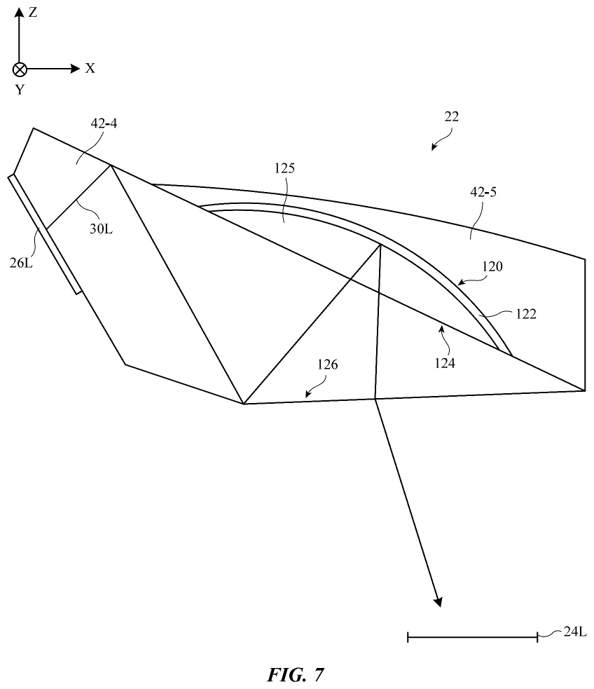

FIG. 6 is an optical diagram showing how the optical layers of optical system 22 of FIG. 4 interact with image light 30L from projector 26L and world light 31 from the environment in implementations where optical system 22 includes QWP 66 and absorption polarizer 68 (e.g., after image light 30L has already total internally reflected off surface 50 at air gap 74).

As shown in FIG. 6, reflective polarizer 58, QWP 72, partial reflector 70, QWP 66, and absorption polarizer 68 may be disposed on the optical path of image light 30L from projector 26L to eye box 24L and on the optical path of world light 31 from the environment to eye box 24L. Image light 30L may be incident upon reflective polarizer 58 after the first reflection (e.g., the total internal reflection) off surface 50 at air gap 74.

Reflective polarizer 58 reflects half (50%) of image light 30L towards QWP 72 as linearly polarized light (e.g., linearly polarized in a direction 90). QWP 56 transmits the linearly polarized light towards partial reflector 70, converting the linearly polarized light to circular polarized light (e.g., circularly polarized in direction 92).

Partial reflector 70 transmits half of the incident circular polarized light (e.g., 25% of the image light 30L output by projector 26L) towards QWP 66 without changing the polarization of the light. Partial reflector 70 also reflects half of the incident circular polarized light back towards QWP 72 while reversing the direction of circular polarization (e.g., into direction 94). This light then propagates to eye box 24L as described in connection with FIG. 5.

The circular polarized light transmitted by partial reflector 70 is received at QWP 66. QWP 66 transmits the incident circularly polarized light towards absorption polarizer 68, converting the circular polarization from direction 98 into a linear polarization at direction 100 (e.g., orthogonal to direction 90). Absorption polarizer 68 transmits linearly polarized light that is polarized in a direction orthogonal to direction 100 (e.g., in direction 102). At the same time, absorption polarizer 68 absorbs (blocks) linearly polarized light that is polarized in direction 100. As such, absorption polarizer 68 prevents any image light 30L from passing to the world, thereby preserving privacy.

At the same time, absorption polarizer 68 transmits half of world light 31 as linearly polarized light polarized in direction 102. QWP 66 transmits this light to circularly polarized light in direction 104 (e.g., opposite direction 98). Partial mirror 70 transmits half of the incident light from QWP 66 without changing its polarization (e.g., transmitting 25% of the world light 31 as incident upon absorption polarizer 68). QWP 66 transmits this light towards reflective polarizer 58 while converting the world light to linearly polarized light polarized in direction 108 (e.g., the same direction as direction 96 and direction 88 of FIG. 5). Reflective polarizer 58 transmits the linearly polarized world light to eye box 24L. QWP 66 and absorption polarizer 68 may similarly preserve the privacy of optical system 22 in the arrangement of FIGS. 3 and 5.

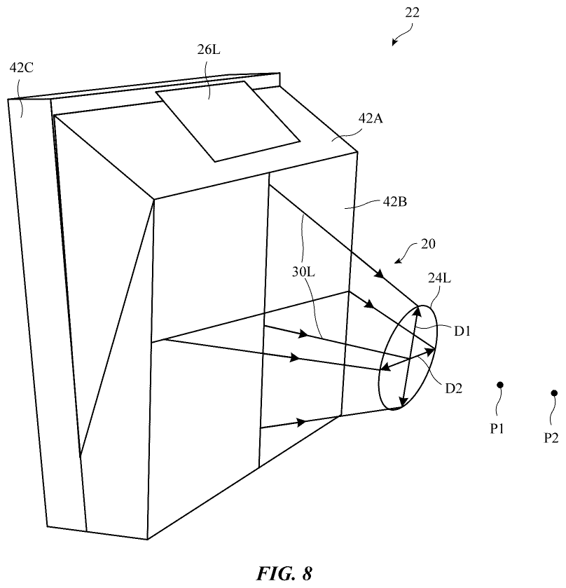

If desired, optical system 22 may be configured to perform more than one total internal reflection on image light 30L to further increase the optical efficiency of optical system 22. FIG. 7 is a top view showing one example of how optical system 22 may be configured to perform more than one total internal reflection on image light 30L. As shown in FIG. 7, optical system 22 may include a first optical wedge 42-4 and a second optical wedge 42-5. Optical wedge 42-4 may have a first surface 124 and a second surface 126 opposite surface 124. Optical wedge 42-5 may have a surface 120 that is mounted or pressed against surface 124.

Optical system 22 may include an air gap 125 between surface 120 of optical wedge 42-5 and surface 124 of optical wedge 42-4. A partial reflector 122 may be layered onto surface 120 within or overlapping air gap 125. Optical wedges 42-4 and 42-5 may be formed from relatively high refractive index materials. Air gap 125 may be filled with air or another dielectric that has a lower dielectric constant than optical wedges 42-4 and 42-5.

As shown in FIG. 7, projector 26L may emit image light 30L into optical wedge 42-4. Image light 30L may reflect off surface 124 in a first total internal reflection. The once-reflected image light 30L passes to surface 126, where the image light 30L is reflected for a second time via TIR (e.g., in a second total internal reflection). The twice-reflected light passes to partial reflector 122 through surface 124 and air gap 125. Partial reflector 122 reflects the image light back into optical wedge 42-4, which passes the image light to eye box 24L.

When configured in this way, optical system 22 may perform at least two total internal reflections on image light 30L, reflective polarizer 58 (FIGS. 3 and 5) may be omitted, and the polarization of the light is not changed between projector 26L and eye box 24L. This may serve to minimize loss of image light 30L, thereby maximizing efficiency. Optical system 22 of FIG. 7 may also be relatively compact, simple to manufacture, and without birefringence restrictions.

If desired, optical system 22 may provide image light 22L within an eye box having a symmetrical (uniform) height and width. For example, as shown in FIG. 8, optical system 22 may include one or more optical wedges 42 (e.g., optical wedges 42A, 42B, and 42C) that pass image light 30L from projector 26L to eye box 24L (e.g., using any of the optical architectures described herein).

Eye box 24L may have a horizontal dimension, field of view, or width D2 and an orthogonal vertical dimension, field of view, or height D1. Width D2 may be equal to height D1. Optical system 22 may be configured to redirect image light 30L such that the horizontal field of view reaches zero eye box (EB) at point P1 with a lower eye relief (ER) than compared to the vertical field of view, which reaches zero EB at a point P2 different (farther) from point P1 (e.g., with a higher eye relief). This effectively configures eye box 24L to have a symmetric and uniform shape such as a circular shape (e.g., having diameter D1=D2) or a square shape (e.g., where height D1=width D2). In implementations where point P1 and point P2 are the same point, the eye box is wider in the horizontal direction (e.g., where interpupillary distance (IPD) adjustment is available). Configuring optical system 22 in this way reduces the need for a wide horizontal eye box (e.g., a rectangular-shaped eye box).

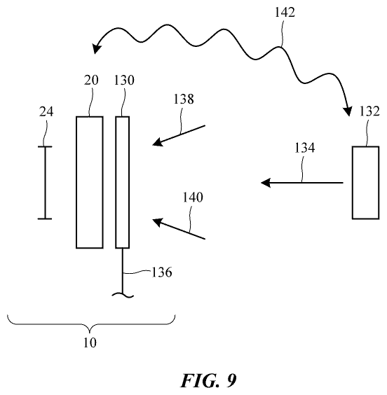

If desired, optical system 22 may be provided with a switchable shutter (e.g., using any of the optical architectures described herein). FIG. 9 is a diagram showing one example of how optical system 22 may be provided with a switchable shutter. As shown in FIG. 9, system 10 may include a switchable shutter 130 overlapping optical system 20 (e.g., at the world-facing side of optical system 20). Switchable shutter 130 may, for example, be a liquid crystal display (LCD) shutter. Switchable shutter 130 may receive electrical control signals over control path 136 (e.g., from the control circuitry of FIG. 1) that switch the shutter between two or more different states. Switchable shutter 130 may transmit or block different amounts of light in each of the states.

If desired, display light 134 from an external device 132 (e.g., a cellular telephone, tablet computer, laptop computer, computer monitor, etc., which may be paired with device 10) may be emitted towards optical system 20. If desired, device 10 and external device 132 may convey wireless signals 142 (e.g., radio-frequency signals) to synchronize the display of display light 134 with the switching of switchable shutter 130. For example, switchable shutter 130 may be placed in a transparent state to pass display light 134 to eye box 24 through optical system 20. The timing of the transparent state may be synchronized with the timing with which external device 132 emits display light 134 such that external device 132 only emits display light 134 while switchable shutter 130 is in the transparent state. Switchable shutter 130 may be toggled between the transparent state and an opaque state and display light 132 may periodically transmit display light (e.g., concurrent with the transparent state) at a relatively fast rate (e.g., faster than the response time of the human eye).

This may configure display light 134 to effectively appear brighter to the user at eye box 24 than other objects around device 10 and may help increase privacy, such that only the user at eye box 24 is able to clearly view display light 134, whereas other persons around device 10 will be unable to clearly view display light 134. For example, display light 134 may periodically include a black and white image that is shown during the transparent state of the switchable shutter so a reader without device 10 is not able to read the text because there is no contrast when the black and white image is time averaged across the frame time of external device 132. Additionally or alternatively, switchable shutter 130 may be switched between first and second states at which light from left and right portions (e.g., as shown by arrows 138 and 140) of a stereoscopic image or display are provided to device 10 from external device 132. This may configure device 10 to form a stereoscopic 3D display, for example.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a display panel configured to emit light; and
an optical system configured to redirect the light, the optical system including
a partial reflector configured to reflect the light at least twice, wherein the partial reflector lies in a first surface that is rotationally asymmetric, and
a reflective polarizer configured to reflect the light and configured to transmit the light, wherein the reflective polarizer lies in a second surface that is rotationally asymmetric.

2. The electronic device of claim 1, wherein the optical system is configured to direct the light towards an eye box along an optical axis, the first surface and the second surface being rotationally asymmetric about the optical axis.

3. The electronic device of claim 2, wherein the first surface is freeform curved.

4. The electronic device of claim 3, wherein the second surface is freeform curved.

5. The electronic device of claim 2, wherein the optical system is configured to provide a horizontal field of view of the light to the eye box at a first point and is configured to provide a vertical field of view of the light to the eye box at a second point farther from the optical system than the first point.

6. The electronic device of claim 1, further comprising:
a first optical wedge having the first surface; and
a second optical wedge having the second surface.

7. The electronic device of claim 6, further comprising an air cavity between the first optical wedge and the second optical wedge.

8. The electronic device of claim 6, further comprising:
a quarter waveplate layered onto the reflective polarizer.

9. The electronic device of claim 6, further comprising:
a third optical wedge between the first and second optical wedges; and
an air gap between the first optical wedge and the third optical wedge and overlapping the partial reflector.

10. The electronic device of claim 9, further comprising:
a quarter waveplate layered onto the partial reflector within the air gap.

11. The electronic device of claim 1, wherein the partial reflector is configured to perform a first reflection on the light and a second reflection on the light, the reflective polarizer is configured to reflect the light after the first reflection and prior to the second reflection, and the reflective polarizer is configured to transmit the light after the second reflection.

12. The electronic device of claim 1, wherein the optical system is configured to transmit world light, the electronic device further comprising:
a quarter waveplate configured to transmit the world light to the partial reflector; and
an absorption polarizer configured to transmit the world light to the quarter waveplate.

13. The electronic device of claim 1, wherein the optical system is configured to transmit world light, the electronic device further comprising:
a switchable shutter configured to transmit the world light to the partial reflector, the switchable shutter being synchronized to a display of an external device.

14. An electronic device comprising:
a display panel configured to emit light;
a first optical wedge having a first surface and a second surface opposite the first surface;
a second optical wedge having a third surface at the second surface;
a third optical wedge having a fourth surface at the first surface;
an air gap defined between a portion of the first surface and a portion of the fourth surface;
a reflective polarizer sandwiched between the second surface and the third surface;
a partial reflector layered on the first surface within the air gap; and
a quarter waveplate layered on the partial reflector within the air gap, wherein the reflective polarizer, the partial reflector, and the quarter waveplate are configured to redirect the light.

15. The electronic device of claim 14, wherein the reflective polarizer is configured to reflect the light after a total internal reflection of the light at the air gap, the partial reflector is configured to reflect the light after reflection by the reflective polarizer, and the reflective polarizer is configured to transmit the light after reflection by the partial reflector.

16. The electronic device of claim 14, wherein the first surface has a freeform curvature that is rotationally asymmetric.

17. The electronic device of claim 14, wherein the third optical wedge has a fifth surface opposite the fourth surface, the electronic device further comprising:
an additional quarter waveplate layered onto the fifth surface and overlapping the partial reflector; and
an absorptive polarizer layered onto the additional quarter waveplate.

18. An electronic device comprising:
a display panel configured to emit light;
a first optical wedge configured to reflect the light twice via total internal reflection;
a second optical wedge having a curved surface separated from the first optical wedge by an air gap; and
a partial reflector layered on the curved surface within the air gap, the partial reflector being configured to receive the light after the light has been reflected by the first optical wedge twice via total internal reflection, the partial reflector being configured to reflect the light towards an eye box through the first optical wedge.

19. The electronic device of claim 18, wherein the eye box has a horizontal dimension and a vertical dimension equal to the horizontal dimension.

20. The electronic device of claim 18, further comprising:
a switchable shutter overlapping the first and second optical wedges, the switchable shutter being configured to transmit light from an external device to the eye box through the first and second optical wedges and the curved surface, and the switchable shutter being synchronized with a display of the external device.
